(19) United States
(12) Patent Application Publication
(10) Pub. No.: US 2011/0219400 A1
(43) Pub. Date: Sep. 8, 2011

(54) APPARATUS AND METHOD FOR REPLACING A BROADCASTED ADVERTISEMENT IN RESPONSE TO AN ATTEMPT BY THE VIEWER TO SKIP OR FAST-FORWARD THROUGH THE ADVERTISEMENT

(75) Inventors: Brant L. Candelore, San Diego, CA (US); Frederick J. Zustak, Poway, CA (US)

(73) Assignee: SONY CORPORATION, Tokyo (JP)

(21) Appl. No.: 12/718,697

(22) Filed: Mar. 5, 2010

(51) Int. Cl. H04N 7/10

(52) U.S. Cl. 725/34

(57) ABSTRACT

According to one embodiment of the invention, an apparatus comprises a tuner/demodulation unit, a data storage unit and a data processing unit. The data processing unit is coupled to the tuner/demodulation unit and the data storage unit. The data processing unit is adapted to detect an operation that accelerates playback of an advertisement that is part of incoming digital content received by the tuner/demodulation unit, and in response to detecting the accelerated playback, to retrieve a secondary advertisement from the data storage unit, to display the secondary advertisement and to display an image that allows the user to discern the remaining time for such a display. The secondary advertisement has a playback time greater than a normal playback time of the advertisement.

### FIELD

The invention is related to the field of content recordation and playback. More specifically, certain embodiments of the invention are directed to the selection, substitution and playback of lesser, time intensive advertisements in lieu of broadcasted television signals.

### BACKGROUND

Currently, television is widely used as a source of both information and entertainment. Cable and satellite systems broadcast tens or even hundreds of channels of programming. Given the large number of programs that are available to a viewer and are broadcast at prescribed times, in some situations, a viewer may be unable to watch all of the programs that he or she wishes to see. Consequently, over the last few decades, a number of electronic devices have been developed to record broadcast television signals.

For instance, video cassette recorders (VCRs) provide viewers with an ability to record incoming audiovisual programs on a magnetic tape and to subsequently view such programs. A timer in the VCR allows the user to record these audiovisual programs at their prescribed broadcasting time. Consequently, the recorded programs are available for playback at the user's convenience.

Thereafter, the basic concept of VCRs has been extended to a hard-drive or semiconductor based recording devices that is commonly referred to as Personal Video (or Versatile) Recorders (PVRs). Normally, a PVR is connected between a viewer's television and that viewer's cable box, satellite receiver or antenna. The PVR can control the channel tuned on the television, provide an interactive electronic program guide and record programs on a manual or timer-controlled basis.

The PVR can buffer incoming audiovisual programs so that the viewer can pause a “live” television program or replay a portion of a live television program without missing any subsequent segment of the program, as long as the pause or replay does not exceed the storage capacity of the PVR. Additionally, the PVR can be programmed to regularly record a user's favorite programs. Consequently, the PVR provides greater flexibility in recording and capturing incoming audiovisual signals than is available with a VCR.

Within broadcast television programs, advertisements (e.g. television commercials) are interspersed between segments of the audiovisual program and are broadcast as part of the television signal. These advertisements are an important source of revenue for the broadcaster and are an important source in reaching current and potential customers with information related to products and services featured in the advertisement.

However, viewers often consider advertising as a nuisance since they normally want to watch a television program without interruption. Consequently, when a viewer has recorded the program using a PVR, the viewer will tend to fast-forward through the program during commercials or skip ahead. Usually there is no audio playback during a “fast-forward” or “skip” operation. Hence, while the audio is muted, the playback of images is accelerated to minimize the interruption in viewing the recorded program.

While such “fast-forwarding” and “skip” operations focus the viewing experience on the audiovisual (television) program, they are detrimental to both the advertiser who is trying to reach potential customers and the broadcaster who depends upon advertising for revenue. As a result, there is a need for a system and method that still allow a viewer who has recorded broadcast programs to minimize the interruption caused by interspersed advertisements, while also protecting the broadcaster's source of revenue.

### BRIEF DESCRIPTION OF THE DRAWINGS

The present invention is illustrated by way of example, and not by way of limitation, in the figures of the accompanying drawings and in which:

FIG. 1A is a first exemplary embodiment of a system implementing an advertisement control unit within a digital device.

FIG. 1B is a second exemplary embodiment of a system implementing an advertisement control unit within a digital device.

FIG. 1C is a second exemplary embodiment of a system implementing an advertisement control unit within a digital device.

FIG. 2 is an exemplary embodiment of the digital device of FIG. 1C.

FIG. 3 is an exemplary embodiment of a user interface produced by the advertisement control unit of the digital device to commence registration of one or more viewers.

FIG. 4 is an exemplary embodiment of a user interface produced by the advertisement control unit of the digital device to program the preferred advertisements for a first viewer.

FIGS. 5A-5C are exemplary embodiments of the user interfaces produced by the advertisement control unit of the digital device to program the preferred genre for the advertisements.

FIGS. 6A-6B are exemplary embodiments of the user interfaces produced by the advertisement control unit of the digital device to program the preferred source of the advertisements.

FIG. 7 is an exemplary embodiment of the user interface produced by the advertisement control unit of the digital device to preclude certain genre of advertisements for particular viewers.

FIGS. 8A-8C are exemplary embodiments of user interfaces produced by the advertisement control unit of the digital device to provide preference ratings for the advertisements.

FIG. 9 is an exemplary embodiment of a user interface used to determine the current viewing audience.

FIGS. 10A-10B are first exemplary embodiments of the content stream format.

FIGS. 10C-10D are second exemplary embodiments of the content stream format.

FIG. 11 is an exemplary embodiment of a display produced in response to a fast-forward or skipping operation when the advertisement skip prevention feature is enabled.

FIGS. 12A-12F are exemplary embodiments of the presentation of advertisements in response to an advertisement skip prevention scheme performed by the advertisement control unit.

### DETAILED DESCRIPTION

In the following description, for the purposes of explanation, numerous specific details are set forth in order to provide a thorough understanding of the present invention. The following description provides exemplary embodiments of the invention, and the accompanying drawings show these various exemplary embodiments for illustrative purposes. However, these examples should not be construed in a limiting sense as they are merely intended to provide exemplary embodiments of the invention rather than to provide an exhaustive list of all possible implementations. In other instances, well-known structures and devices are not shown in block diagram form in order to avoid obscuring the details of the invention.

In the following description, certain terminology is used to describe features of the invention. For instance, the term “digital device” may refer to consumer electronic equipment that is adapted to perform one or more of the following operations on transmissions from a content provider: tune, receive, decrypt, descramble and/or decode. Examples of consumer electronic equipment may include, but are not limited or restricted to a television, a set-top box, a personal digital assistant (PDA), a computer, a telephone that is cellular or wireless enabled, a video game console, a portable or stationary music player, a personal video recorder (PVR), or the like. Also, examples of a “content provider” include, but are not limited or restricted to a terrestrial broadcaster, a cable or satellite television distribution system, or a company providing content for download over the Internet or other Internet Protocol (IP) based networks like an Internet Service Provider (ISP).

Also, in certain situations, the terms “unit” and “logic” are representative of hardware, firmware and/or software configured to perform one or more functions. Examples of “hardware” include, but are not limited or restricted to an integrated circuit such as memory or a processor (e.g., a digital signal processor, microprocessor, application specific integrated circuit, a micro-controller, a type of programmable gate array, etc.). Of course, the hardware simply may be a collection of combinatorial logic.

An example of “software” includes executable code in the form of an application, an applet, a routine or even a series of instructions. The software may be stored in any type of machine readable medium such as a programmable electronic circuit, a semiconductor memory device such as volatile memory (e.g., random access memory, etc.) and/or non-volatile memory (e.g., any type of read-only memory “ROM”, flash memory, etc.), a hard drive disk, a flash drive, a floppy diskette, an optical disk (e.g., compact disk or digital video disc “DVD”), magnetic tape, or the like.

I. Exemplary System/Device Architecture

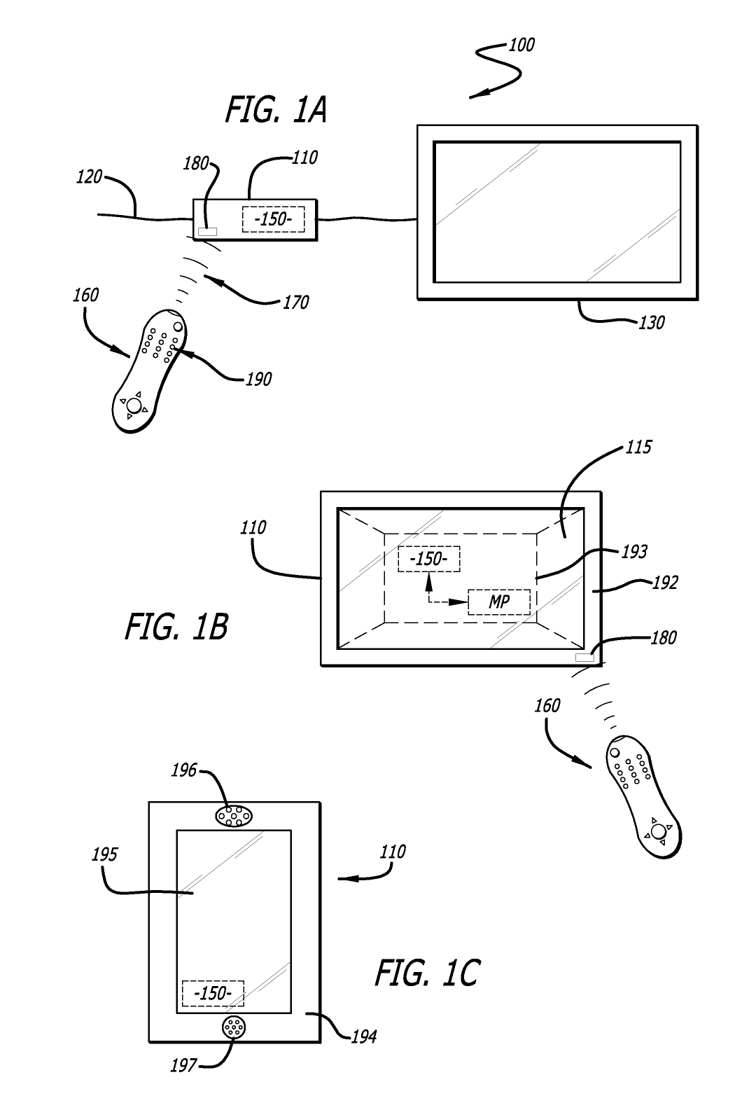

Referring to FIG. 1A, a first exemplary embodiment of a content delivery system 100 implementing an advertisement control unit within a digital device is shown. One purpose of content delivery system 100 is to deliver content from a content provider to a targeted destination. This targeted designation includes a digital device 110 (e.g., set-top box or PVR) that is in communication with the content provider over an input link 120 to receive digital content that includes advertisements (e.g., video and/or audio) interspersed between segments of an audiovisual program. The advertisements may be delivered in the same channel as the audiovisual program and even within the same data stream. Alternatively, of course, the advertisements may be delivered over a different channel from the audiovisual program.

According to this embodiment of the invention, digital device 110 is further coupled to a second digital device, such as a television 130 for example, that is adapted to display the content. Digital device 110 includes an advertisement control unit 150 that is adapted to identify, select and/or substitute advertisements geared toward a particular viewer of television 130.

Being a wireless controller that is remotely located from digital device 110, a remote 160 controls the operations of advertisement control unit 150. Remote 160 is adapted to communicate commands through a communication link 170 established between remote 160 and digital device 110. In particular, according to this embodiment of the invention, the communication link 170 is a wireless light emitting diode (LED) communication path through which remote 160 sends commands that are formed as light pulses. These light pulses are detected by a LED detector 180 located on digital device 110. Alternatively, link 170 may be radio-frequency signaling or wireless signaling of other bandwidths where detector 180 constitutes an RF detector.

As shown, a particular command from remote 160 may be produced by depressing buttons 190 accessible on an outer top surface of remote 160. Buttons 190 may include a power button, a key of a keypad designating numerals and/or characters, a select button with multidirectional arrows that provide scrolling as needed, or the like.

Referring now to FIG. 1B, a second exemplary embodiment of content delivery system 100 implementing advertisement control unit 150 within digital device 110 is shown. Herein, digital device 110 is a device with a display screen 115. Similar to FIG. 1A, detector 180 is implemented within a casing 192 of digital device 110, namely a flat paneled television. Detector 180 detects signals from remote 160 and transfers those signals (e.g. commands) to a processor (MP) located on a back cabinet 193 of television 110. Herein, the processor receives the commands and issues appropriate signaling to advertisement control unit 150 in order to provide information regarding the viewing audience and/or advertisement selections for substituting advertisements between segments of the audiovisual program as necessary.

Referring to FIG. 1C, a third exemplary embodiment of a system implementing advertisement control unit 150 within digital device 110 is shown. Herein, digital device 110 is portable with an integrated display, such as cellular telephone for example. Cellular telephone 110 includes a casing 194, a user interface 195 (e.g. touch screen, keypad, etc.), a speaker 196 and a microphone 197. Herein, advertisement control unit 150 may be hardware, firmware or software such as a downloadable application that is executed by a processor implemented within casing 194 of cellular telephone 110. For that embodiment of the invention, advertisement control unit 150 either can be (i) prestored within local memory of telephone 110 at manufacturer, (ii) stored prior to distribution to the user, or (iii) downloaded into local memory by the user initiating communications with a remote source such as an application server. These communications may be over a private or public network to an application server hosted by any of the following: the cellular telephone service provider, the telephone manufacturer/distributor, or a third party.

According to one embodiment of the invention, upon downloading advertisement control unit 150 into local memory of telephone 110, it operates in the background by monitoring and substituting advertisements associated with audiovisual programs played back on telephone 110. Of course, it is contemplated that advertisement control unit 150 may operate in the foreground in order to provide the user with greater control of the advertisement selection process.

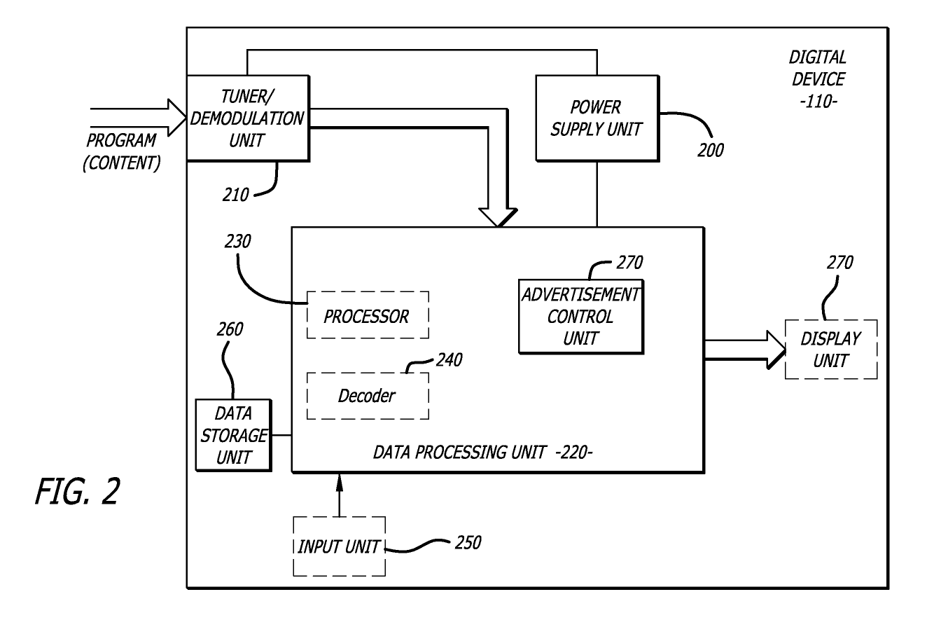

Referring now to FIG. 2, an exemplary diagram of an embodiment of digital device 110 of content delivery system 100 is shown. According to this embodiment of the invention, digital device 110 comprises a power supply unit 200, a tuner/demodulation unit 210 and data processing unit 220. Power supply unit 200 is adapted to provide power to tuner/demodulation unit 210 and data processing unit 220. Power supply unit 200 may provide regulated power based on input power received from a wall socket (e.g., 110 volts alternating current “VAC”, 220 VAC, etc.) or a battery. Tuner/demodulation unit 210 tunes to a channel to receive an incoming digital content and demodulates the content to recover the advertisements and the audiovisual program. The audiovisual program and the advertisements are routed as a digital bit stream to data processing unit 220.

According to one embodiment of the invention, data processing unit 220 comprises a processor 230 and/or a decoder 240. These components may be implemented as separate integrated circuits or as a single integrated circuit. As described herein, data processing unit 220 features logic operating to decode and process incoming information as well as advertisement control unit 150 that is adapted to alternatively select the genre and source of advertisements that are fetched/filtered and stored within digital device 110 for subsequent playback during viewing of the audiovisual program. An input device 250 may be implemented as an integral part of digital device 110 or may be separate and remotely located from digital device 110 (not shown).

In general, according to one embodiment of the invention, advertisement control unit 150 is adapted to generate user interfaces for registration purposes and to replace broadcast advertisements with advertisements fetched from a data storage unit 260 that operates as local memory for digital device 110. The replacement scheme may involve tags within the broadcast program to identify what advertisements are to be fetched from data storage unit 260. Another replacement scheme may involve data processing unit 220 accessing metadata within an Adaptation field of one or more Motion Picture Experts Group (MPEG) packets associated with an advertisement in order to provide signaling to advertisement control unit 150 regarding the genre or subject matter of the advertisement. This meta data allows advertisement control unit 150 to determine whether the genre or subject matter of the advertisement is preferred by the viewer for playback on a display unit 270. Display unit 270 may be implemented as an integral part of digital device 110 or may be separate and remotely located therefrom (not shown).

II. Exemplary Registration Process

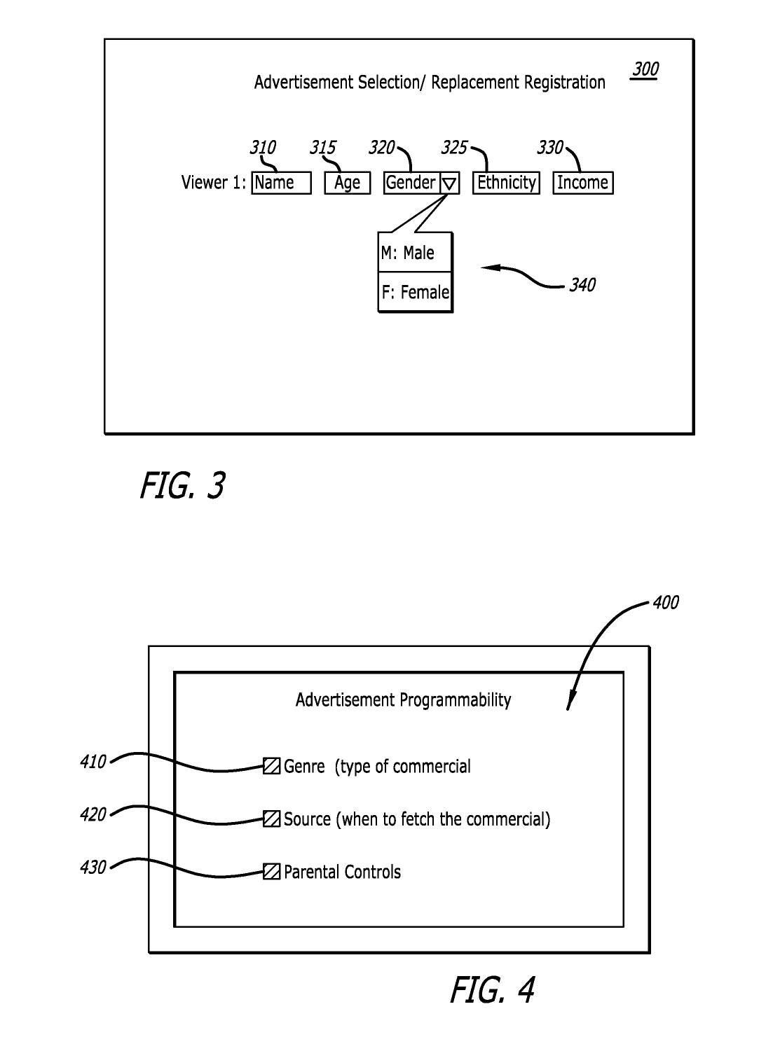

Referring to FIG. 3, an exemplary embodiment of a user interface produced by advertisement control unit 150 of digital device 110 of FIG. 2 to commence registration of one or more viewers is shown. Herein, a registration image 300 is displayed by digital device 110 in order to allow the viewer or viewers to provide personal information. Herein, a viewer can use a remote or keypad associated with digital device 110 in order to enter alphanumeric characters that will provide some or all of the following information concerning the viewer(s): (1) name 310; (2) age 315; (3) gender 320; (4) ethnicity 325; and (5) income level 330.

For some of the viewer-based information, pull-down menus may be provided to allow the viewer to select the appropriate entry. For instance, as shown, a pull-down menu 340 may be provided with two entry selections: male “M” and female “F”. Additionally, pull-down menus may be provided for some of the other categories such as age, ethnicity, and income level. The “name” category however will most likely be input by the viewer via buttons on a remote or those associated with a digital device or an input mechanism integrated on digital device 110 such as a keypad, a touch screen, or the like.

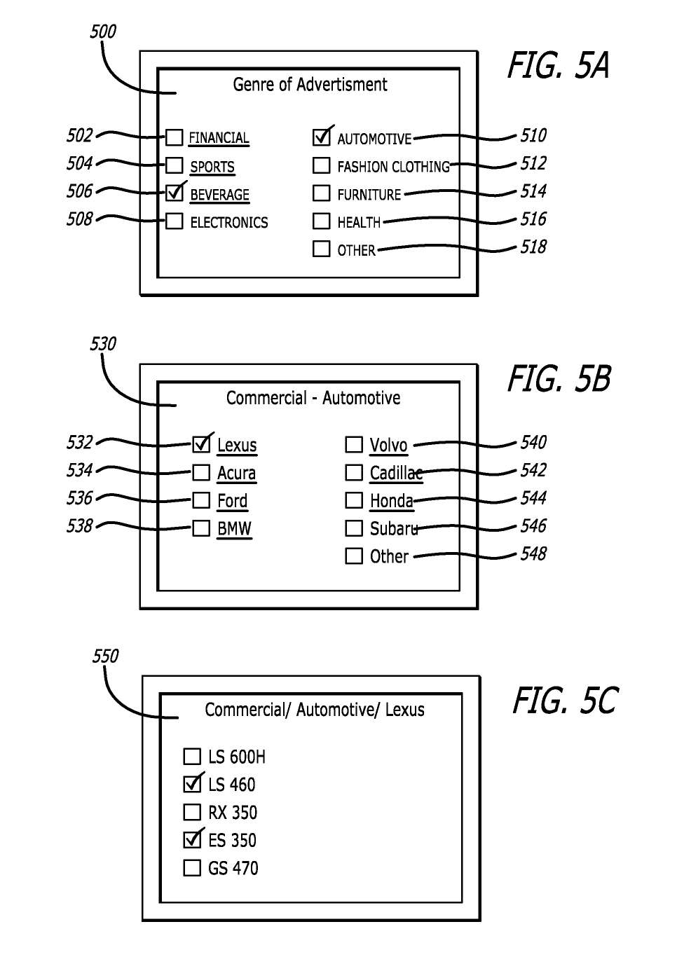

Referring now to FIG. 4, an exemplary embodiment of a user interface 400 produced by the advertisement control unit of the digital device to program the preferred advertisements for a first viewer is shown. Herein, user interface 400 provides a plurality of parameters for use in selecting preferred advertisements. For instance, as an example, these parameters include, but are not limited or restricted to a genre parameter 410, a source parameter 420 and a parental control parameter 430.

Genre parameter 410 is used to identify particular types of advertisements that the viewer would like to see interspersed between television programming. Source parameter 420 provides information from where the digital device is to fetch the advertisements. Parental control parameter 430 provides a mechanism to exclude certain types of advertisements from being displayed on the digital device. For instance, the parental controls may be viewer specific to exclude the displaying of a type of advertisement when a particular viewer is watching or may be generally applied to excluding this type of advertisement from being displayed on the digital device.

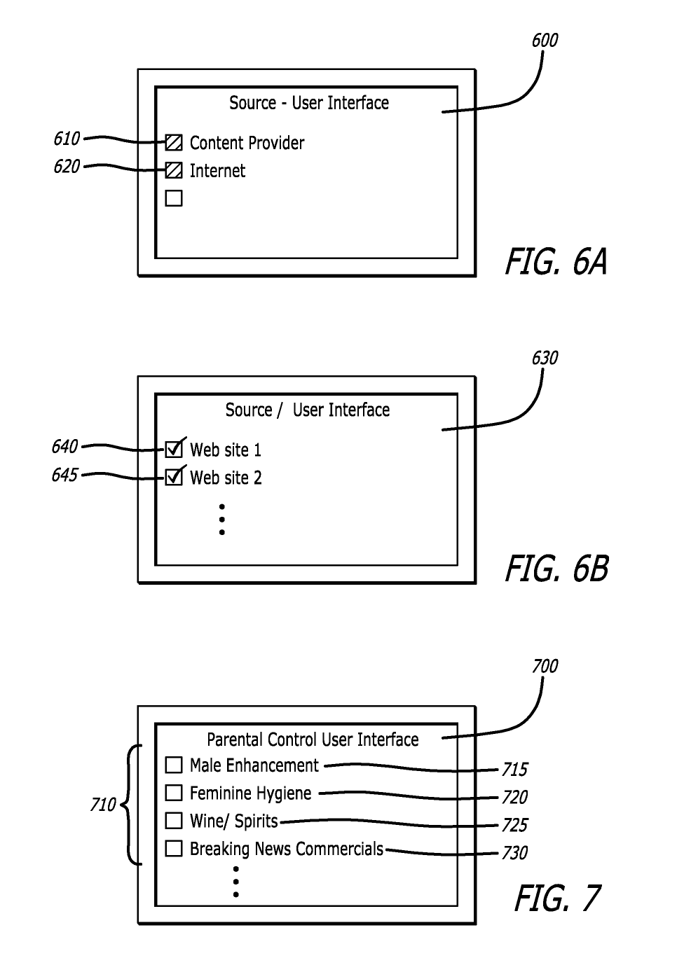

Referring now to FIGS. 5A-5C, exemplary embodiments of selectable user interfaces produced by the advertisement control unit of the digital device in order to program the preferred genre of the advertisements is shown. Herein, FIG. 5A illustrates a first user interface 500 of advertisement genre that is selectable by the viewer. According to this embodiment of the invention, the advertisement genre includes, but is not limited or restricted to financials 502, sports 504, beverages 506, electronics 508, automotive 510, fashion clothing 512, furniture 514, health 516 and other 518. Herein, the viewer selects the genre of advertisements that he or she would be willing to watch in full or in an abbreviated mode in order to customize the advertisement viewing for that particular user.

According to one embodiment of the invention, at least one genre is required to be selected before proceeding to the next user interface of the advertisement selection scheme. Herein, the beverage and automotive categories 506 and 510 are selected by the viewer. In event that the “other” category 518 is selected, another selectable user interface (e.g., screen display) with additional advertisement genres is displayed for the viewer to choose different categories for this particular genre.

Of course, in lieu of selecting the particular genres that are acceptable to the viewer, interface 500 may be adapted so that all of the genre categories are selected. Now, the viewer would need to deselect the particular genre category or categories that he or she does not want to view.

Referring to FIG. 5B, a second user interface 530 is provided which provides greater granularity as the particular types of automotive advertisements that would be available to the viewer. Herein, according to one embodiment of the invention, the automotive advertisements are categorized according to the make of a particular type of automotive vehicle such as, for example, Lexus® 532, Acura® 534, Ford® 536, BMW® 538, Volvo® 540, Cadillac® 542, Honda® 544, Subaru® 546 and Other 548. According to another embodiment for this user interface, the automotive advertisements may be categorized according to make/model of these automotive vehicles.

In the event that the viewer selects one of the “make” categories illustrated in FIG. 5B, such as the Lexus® category for example, an additional user interface 550 is provided as shown in FIG. 5C. Of course, user interface 550 may be produced automatically or in response to selection of an entry (not shown). As shown, for this embodiment of the invention, user interface 550 is a selectable screen display that allows the user to select the particular “model” of the vehicle for which advertisements will be played back for the viewer. For this illustrative example, Lexus® LS460 and Lexus® ES350 sedans are selected.

If none of the vehicle models are selected, all Lexus® models will be selected by default in order to comply with the viewer's request for Lexus® advertisements in user interface 530 of FIG. 5B. Similarly, for the automotive “makes” set forth in FIG. 5B, in the event that none of these are selected by the viewer, the advertisement control unit enters into a default state where all automotive makes are selected in order to comply with the viewer's request for automotive advertisements in user interface 500 of FIG. 5A.

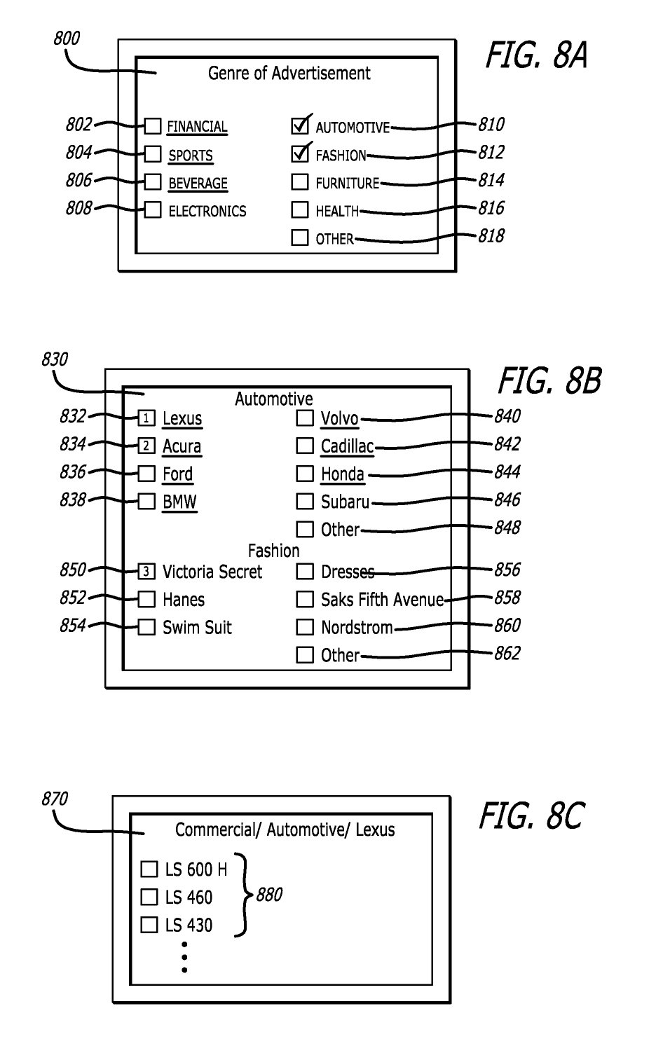

Referring now to FIGS. 6A and 6B, user interfaces 600 and 630 are shown in order to allow the viewer to select the particular source upon which the advertisements may be extracted. As shown in FIG. 6A, user interface 600 displays the sources from which advertisements can be recovered or obtained. These sources may include, but are not limited or restricted to a particular content provider 610 or various websites accessible over the Internet 620. Upon selecting advertisements from the content provider, advertisements periodically may be uploaded to the digital device therefrom and stored in local memory for subsequent retrieval. The periodicity of the uploading may be on a daily basis or with greater periodicity such as on an hourly basis.

Upon selecting the Internet parameter, a user interface 630 is generated, which is illustrated as a screen display that lists websites 640 and 645 from which the advertisements may be downloaded. These websites 640 and 645 may be dedicated websites for particular advertisers or websites of particular content providers or broadcasters. Alternatively, the websites may be a video based website from which revenue could be realized by the broadcasters from advertisements extracted from that particular website.

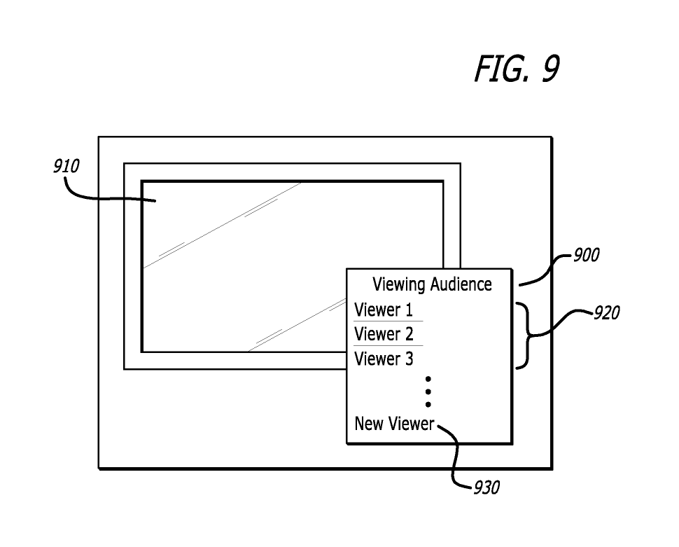

Referring now to FIG. 7, an exemplary embodiment of the parental control user interface 700 is shown. Herein, various adult-oriented genres 710 are listed to enable a guardian of the viewer to select particular genres or advertisement categories that the viewer should not be allowed to view. For instance, such categories may include, for example, male enhancements 715, feminine hygiene products 720, wine & spirits 725, breaking news commercials 730 which are normally geared toward sensationalism, and the like. By selecting any of “parental control” genre, the advertisement control unit prevents such genre from being displayed.

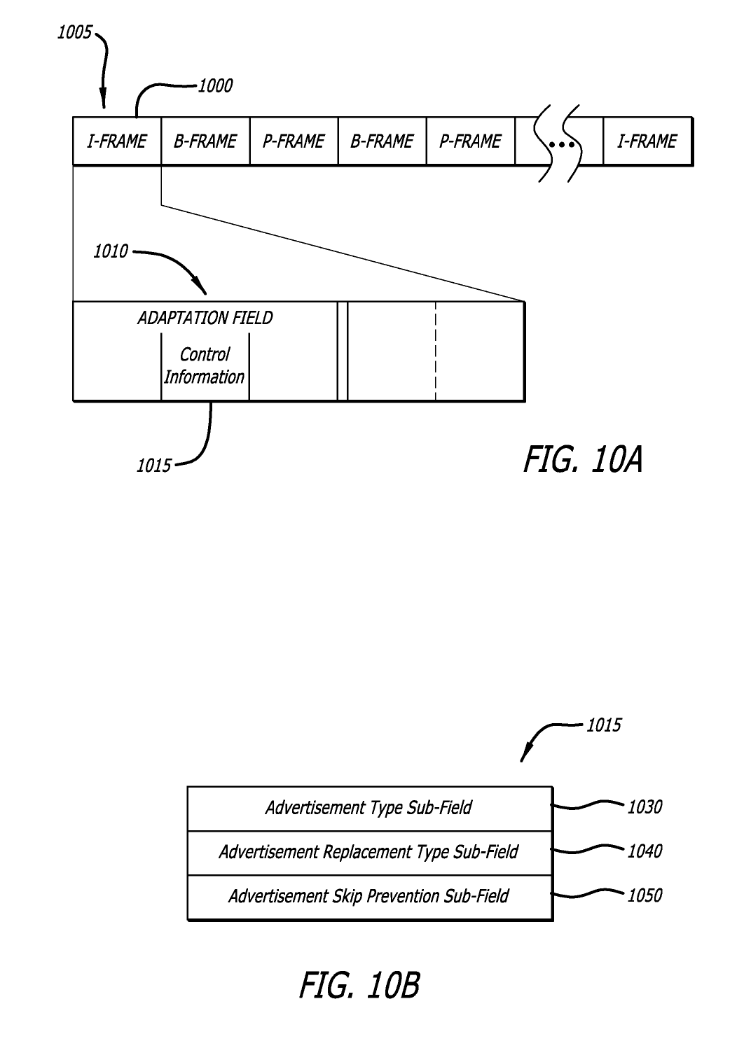

Referring now to FIGS. 8A-8C, exemplary embodiments of selectable user interfaces produced by the advertisement control unit of the digital device in order to program the preferred genre of the advertisements according to a rating scheme is shown. Herein, FIG. 8A illustrates a first user interface 800 of advertisement genre that is selectable by the viewer. According to this embodiment invention, the advertisement genre includes, but is not limited or restricted to financials 802, sports 804, beverages 806, electronics 808, automotive 810, fashion 812, furniture 814, health 816 and other 818. Herein, the viewer selects the genre of advertisements that he or she would be willing to watch in full or abbreviated mode in order to customize the advertisement viewing for that particular user.

According to one embodiment of the invention, at least one genre is required to be selected before proceeding to the next segment of the advertisement selection scheme. Herein, the automotive and fashion categories 810 and 812 are selected by the viewer. As previously described, in event that an “other” category 818 is selected, another user interface (e.g., screen display) with additional advertisement genres is displayed for the viewer to select different categories for this particular genre. Alternatively, in lieu of selecting the particular genres that are acceptable to the viewer, user interface 800 may be adapted so that all of the genre categories are selected. Now, the viewer would need to deselect the particular genre category or categories that he or she does not want to view.

Referring to FIG. 8B, a second user interface 830 is provided which provides greater granularity as to the particular types of automotive and fashion advertisements that are acceptable to the viewer. Herein, according to one embodiment of the invention, the automotive advertisements are categorized according to the make of a particular type of automotive vehicle such as, for example, Lexus® 832, Acura® 834, Ford® 836, BMW® 838, Volvo® 840, Cadillac® 842, Honda® 844, Subaru® 846 and Other 848. The fashion advertisements are categorized according to clothing maker, clothing type and/or store such as Victoria Secret® 850, Hanes® 852, swimsuit 854, dresses 856, Saks Fifth Avenue 858, Nordstrom 860, and other 862.

Instead of selecting the categories, the viewer can use the remote or input device to provide preference ratings for each of these categories. For instance, according to this example, Lexus® and Acura® advertisements are rated “1” and “2” by depressing a corresponding numeral on the keypad of the remote while Victoria Secret advertisements was rated “3”. Further granularity of advertisements may be provided as described above, where each category provides sub-categories for the user to select.

As shown in FIG. 8C, for this embodiment of the invention, user interface 870 is a selectable screen display that allows the user to select the particular “model” 880 of the vehicle for which advertisements will be played back for the viewer. If none of the vehicle models are selected, all Lexus® models will be selected by default in order to comply with the viewer's request for Lexus® advertisements in user interface 830 of FIG. 8B.

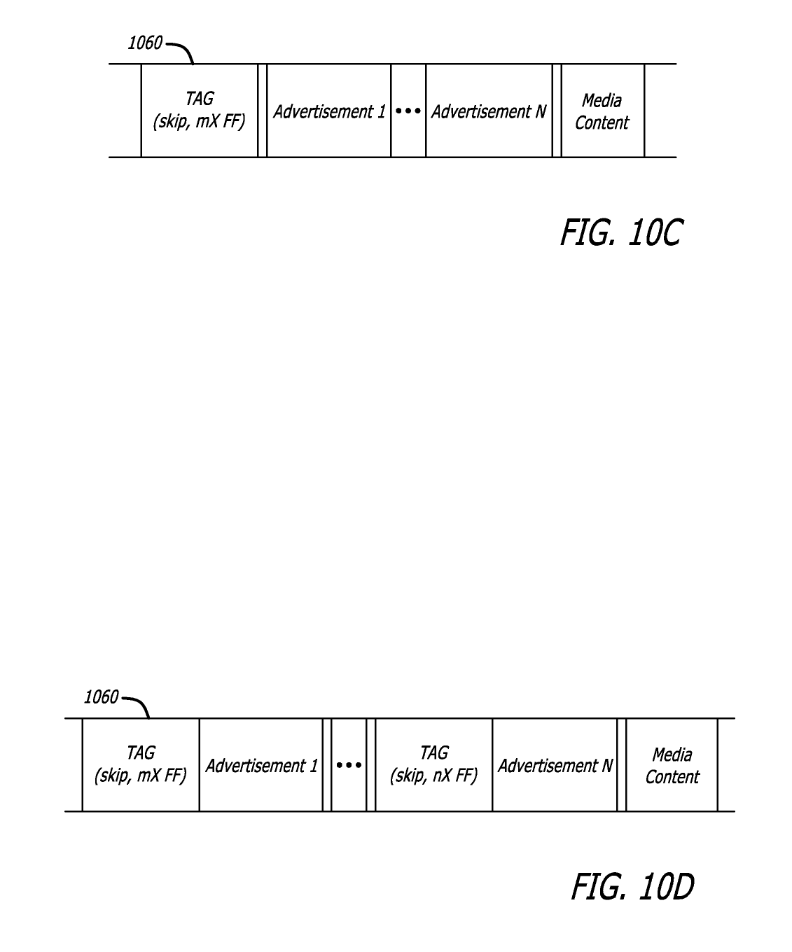

Referring now to FIG. 9, after a viewer has registered his or her advertisement preferences, the advertisement control unit provides a control panel that identifies which registered viewer(s) is(are) currently watching the program. According to this embodiment of the invention, a control panel 900 is superimposed over an audiovisual program 910 that is being watched. Control panel 900 is used to determine the current viewing audience in order to provide appropriate controls signals to the advertisement control unit for advertisement selection.

Herein, control panel 900 includes one or more selectable entries 920 that are each associated with a registered viewer and designate which of the registered viewers form the viewing audience. An additional entry 930, when selected, begins registration of a new viewer. Upon selection of an entry associated with a registered viewer, the advertisement control unit is provided information that the registered viewer is part of the viewing audience. Hence, the advertisements will be tailored to the viewing audience. Control panel 900 may be displayed at initial power-on of the digital device and may be intermittently displayed automatically or in response to commands initiated by the viewer via the remote or a panel located on the digital device itself.

In the event that the viewing audience is identified as consisting of multiple registered viewers, the advertisement control unit determines if there is a subset of advertisements that are preferred by the entire viewing audience. In the event that the viewers substantially differ in advertisement preferences, and thus no subset can be computed, the advertisement control unit selects those advertisements that are preferred by any of the registered users. The advertisements may be pseudo-randomly selected or may be selected according to a particular pattern. For instance, the advertisements may be intermixed so that the first advertisement is of a genre preferred by the first viewer while the second advertisement is of a genre preferred by the second viewer, and the like.

If parental controls are in place for at least one of the viewers or for the digital device in general, the genre of advertisements that have been disallowed from viewing will not be shown, even if one of the viewers has such advertisements as part of his or her preferences. Besides mere selection of entries by the viewers, passwords may be required where parental controls are in effect.

Control panel 900 may also be used to remove a registered viewer from the viewing audience by deselecting the viewer who now will not be part of the viewing audience. As an example, this would remove a designation (e.g. underline, highlight, etc.) from the viewer's listed name. As a result, the advertisements may be specifically tailored to the remaining viewer(s).

Of course in lieu of viewer registration, it is contemplated that the registration process could be directed toward a category of users such as “adults” and “minors” for instance. In this situation, the viewer can be tailored to a broad category of viewers.

III. Exemplary Content Stream Formats

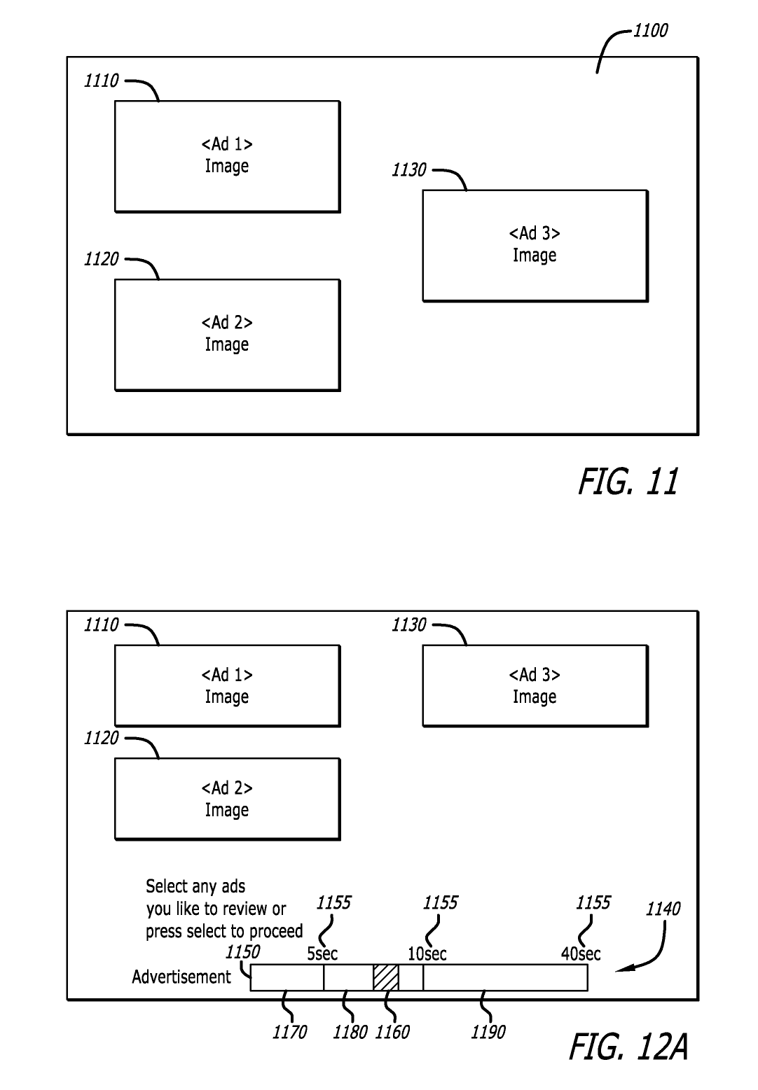

For instance, as shown in FIG. 10A, an exemplary diagram of an adaptation field 1010 of an I-frame 1000 is shown. Adaptation field 1010 is a portion of a MPEG packet 1005 of a digital data stream, where according to this embodiment, MPEG packet 1005 is associated with an advertisement to be displayed. Adaptation header 1010 features control information 1015 to indicate (i) whether an advertisement skip prevention feature is enabled, and/or (ii) the genre of the advertisement.

More specifically, according to this particular embodiment of the invention, adaptation header 1010 comprises control information 1015 that includes at least one bit to indicate whether the advertisement skip prevention feature is enabled. This enables the digital device to operate in two or more modes, where at least one mode is designed to prevent fast-forwarding/skipping of advertisements (i.e. advertisement skip prevention feature). For instance, when control information 1015 includes three bits, the digital device may operate in eight or less modes as set forth below in Table A.

TABLE A

| Mode | Fast-Forwarding | Skip |
|---|---|---|
| 0 | Permitted at all rates > normal playback | Permitted |
| | rate (All FF) | |
| 1 | Permitted at all rates > normal playback | Prohibited |
| | rate (All FF) | |
| 2 | Prohibited at rate ≧30 times normal | Prohibited |
| | playback rate (30X FF) | |
| 3 | Prohibited at rates ≧16 times normal | Prohibited |
| | playback rate (16X & 30X FF) | |
| 4 | Prohibited at rates ≧8 times normal | Prohibited |
| | playback rate (8X, 16X & 30X FF) | |
| 5 | Prohibited at rates ≧2 times normal | Prohibited |
| | playback rate (2X, 8X, 16X & 30X FF) | |

As set forth in FIG. 10B, control information 1015 of adaptation header 1010 comprises a plurality of sub-fields, including but not limited or restricted to one or more of the following: (1) advertisement type sub-field 1030; (2) advertisement replacement type sub-field 1040; and (3) advertisement skip prevention sub-field 1050.

Advertisement content type sub-field 1030 identifies the genre of advertisement intended for display. This information may be used by advertisement control unit 150 of FIG. 2 to select various types of replacement advertisements, if advertisement replacement is supported.

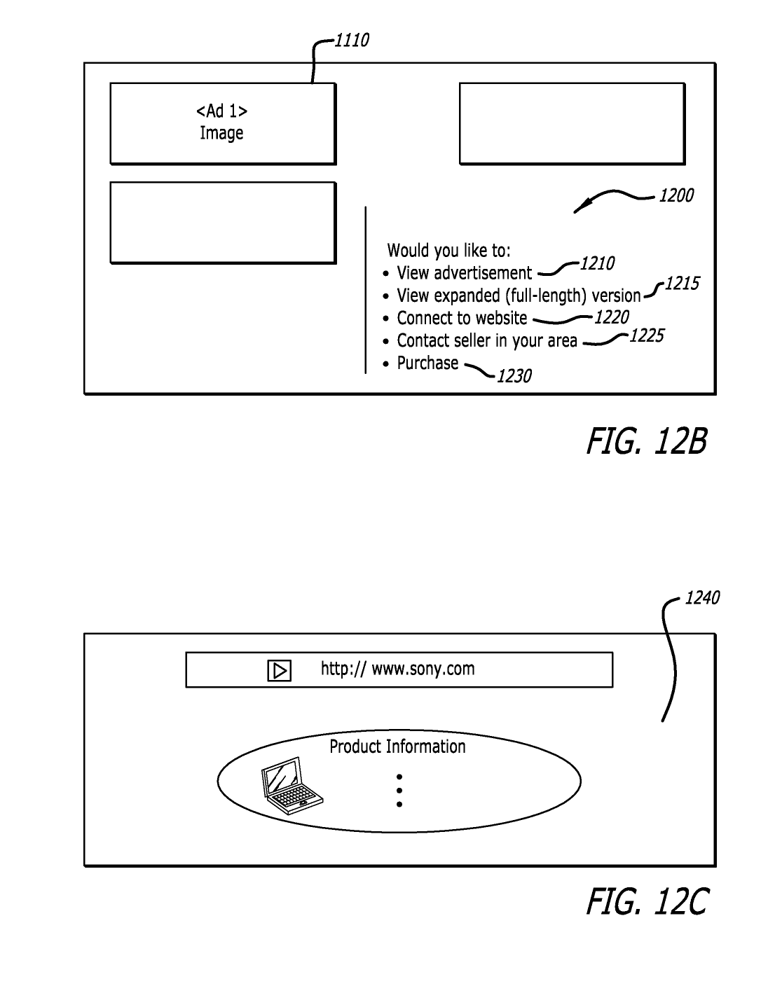

Advertisement replacement type sub-field 1040 identifies the type of replacement schemes that are available in response to detection of an accelerated playback of an advertisement (e.g., fast-forwarding and/or skipping) by the advertisement control unit. For instance, in response to a particular action to reduce the viewing time of the advertisement (e.g., 30× FF or skip), the advertisement control unit may substitute the advertisement with a different full-length advertisement previously selected by the user. Alternatively, the advertisement control unit may cause the digital device to operate in an abbreviated mode in which a partial-length audiovisual advertisement(s) or an advertisement with static image(s) is substituted for the broadcast advertisement(s). These “abbreviated” advertisements have a display time that is less than the normal fifteen or thirty seconds allocated for broadcast advertisements as shown in FIG. 11.

Advertisement skip prevention sub-field 1050 identifies whether there are restrictions against fast-forwarding and/or skipping of a particular advertisement, and if so, to what degree is fast-forwarding and/or skipping permitted. If the viewing times for the advertisements are precluded from being altered, as during substantially “live” broadcasts, the advertisement replacement type sub-field 1040 may be used to identify how to handle advertisements displayed in response to a fast-forward or skip operation being selected during playback of the advertisement.

Alternatively, it is contemplated that the control information may be placed in another location within the content stream other than the adaptation header 1010 of FIG. 10A. For instance, as shown in FIGS. 10C and 10D, the control information may be placed within a tag 1060 that precedes one or more advertisements. Tag 1060 includes information that (1) identifies the genre of advertisement intended for display; (2) identifies the type of replacement schemes that are available in response to detection of an accelerated playback of an advertisement; (3) identifies whether there are restrictions against altering of a broadcast advertisement (e.g., fast-forwarding up to “m×” or “n×” times playback speed, skipping, pausing, muting, etc.); or any combination thereof. For instance, if there are restrictions, the information further indicates what alterations are permitted. As an example, the advertisement may allow for 2× or 8× fast forwarding, but in response to a fast forwarding operation of 30× or more, a static advertisement is displayed for a few seconds.

IV. Exemplary Advertisement Replacement Scheme

Referring now to FIG. 11, an exemplary embodiment of a display produced in response to a fast-forward or skipping operation when the advertisement skip prevention feature is enabled is shown. Display 1100 features three static images 1110, 1120, and 1130. In lieu of displaying an advertisement at an accelerated playback rate upon detecting that the user is fast-forwarding at a certain rate (e.g. 30×), or is skipping the advertisement, the advertisement control unit detects the fast-forwarding/skipping operation and produces static images for display. The display time may range anywhere from a few seconds up to or around fifteen seconds in duration. The static images are produced from data stored in the display device that is retrieved in response to detecting a fast-forwarding/skipping action by the user.

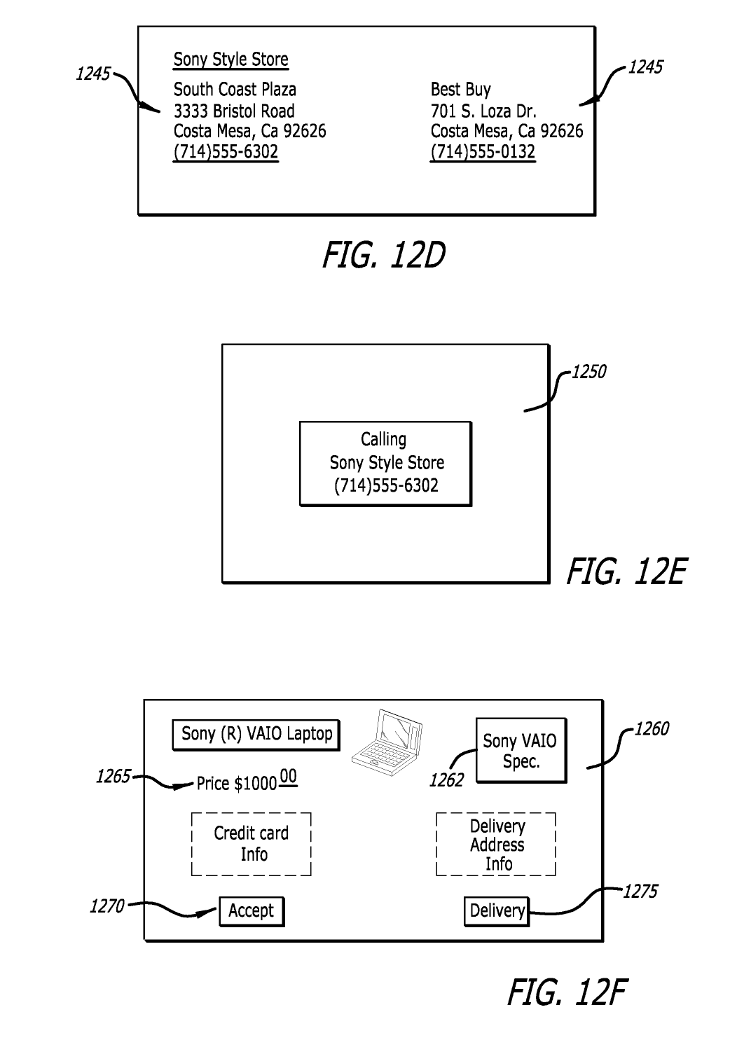

Referring now to FIGS. 12A-12F, exemplary embodiments of the presentation of advertisements in response to operations of an advertisement skip prevention scheme are shown. Referring to FIG. 12A, static images 1110-1130 of various products and/or services that are associated with advertisements to be displayed at the display unit are uploaded into the digital device and retrieved by the advertisement control unit in response to detecting a fast-forwarding skip operation (e.g., 8×-to-30×). The particular fast-forwarding operation may be for all forwarding or merely forwarding beyond a certain rate threshold such as 8× rate. Upon displaying static images 1110-1130, the viewer may select any of these advertisement images if further viewing is desired. This would cause a secondary screen display to appear as shown in FIG. 12B.

Besides displaying static images 1110-1130 or any other replacement advertisements, when the broadcast advertisement is permitted to be altered (e.g., fast-forwarded, paused, skipped, and/or muted), an advertisement progression element 1140 is displayed. According to one embodiment of the invention, advertisement progression element 1140 features a time scale 1150 that includes indicia 1155 to specify time durations. Time scale 1150 may be set to a prescribed time or may be adjustable depending on the anticipated time duration for the commercials scheduled for display. For this embodiment, the time durations are in intervals of thirty (30) seconds although other durations may be used.

An indicator 1160 is provided that overlays time scale 1150 and illustrates how much time, in the advertisement viewing process, is remaining. For instance, as shown, a first “abbreviated” advertisement 1170 ran five (5) seconds and a second “abbreviated” advertisement 1180, such as the display of images 1110-1130 is being conducted to run five (5) seconds. A third advertisement 1190 may not be fast forwarded, and thus, the advertisement control unit will cause a disengagement from fast-forward mode and simply playback third advertisement 1190 over its full thirty (30) second duration.

In FIG. 12B, a first advertisement 1110 is selected and provides a screen menu 1200 as to options that the viewer has in the event that he or she wants to utilize services and/or products associated with the advertised content. For instance, as shown in FIG. 12B, the options include, but are not limited to or restricted to the following: (1) viewing the audio/visual program associated with the advertisement (item 1210); (2) viewing an expanded or full-length version of advertisement of the products or services listed in the image (item 1215); (3) connect to a web-site that sells or distributes the product or services listed in the image (item 1220); (4) contact a seller or manufacturer in your area to order or inquire about the products or services listed on the image (item 1225); and (5) purchase the goods/services for delivery to the address registered by the user (item 1230).

For instance, as shown in FIG. 12C, upon selecting a web-site associated with an entity that manufactures or distributes (sells) the product, a new user interface 1240 is provided that links to the URL to allow the user to obtain further information on the product or even purchase the product.

Similarly, when the user selects the “contact seller in your area” option 1225, as shown in FIG. 12D, as list 1245 of manufacturers and/or distributers of the listed product is shown. Herein, the addresses of the Sony® Style Store are shown in which the purchase of a VAIO® computer may be purchased at the Sony® Style store or at a local electronics retail store such as Best Buy.

As shown in FIG. 12E, upon selecting the phone number associated with the Sony® Style store, display 1250 indicates that the digital device is calling the Sony® Style store so that verbal inquiries regarding the operations of the VAIO® computer and the availability of the VAIO® computer in the warehouse is made.

Referring to FIG. 12F, upon selecting the “purchase” option 1230 in FIG. 12B, a listing 1260 is provided in which indicates the price of the goods being illustrated, namely the SONY® VAIO® laptop, and information associated therewith (e.g., specification data 1262). Herein, in user interface 1260 of FIG. 12F, purchase price 1265 of the SONY® VAIO® laptop is shown, which allows the potential consumer to select the “Accept” image 1270 illustrated on the left side of user interface 1260 that prompts entry of a credit card number for a secure purchase over the Internet. In addition, the user interface further comprises a delivery button 1275 that, when selected, allows the user to designate where the purchased product is to be delivered. In the event that no delivery address is provided, the delivery address used is the most recent address for mailing credit card statements to the card holder.

Having disclosed exemplary embodiments and the best mode, modifications and variations may be made to the disclosed embodiments while remaining within the spirit of the invention as defined by the following claims.

What is claimed is:

1. An apparatus comprising:
a data storage unit; and
a data processing unit coupled to the data storage unit, the data processing unit being adapted to detect a fast-forwarding operation during playback of an advertisement being part of downloaded digital content, determine whether the advertisement is permitted to undergo the fast-forwarding operation and if so, (i) output at least one static advertisement image that is retrieved from the data storage unit and is part of a genre selected by a viewer and (ii) output an image for display to illustrate a remaining duration for viewing of the advertisement.

2. The apparatus of claim 1 further comprising a display unit coupled to the data processing unit.

3. The apparatus of claim 2 being a portable cellular telephone with the data storage unit and the data processing unit encased within a casing and the display unit integrated as part of the casing.

4. The apparatus of claim 2 being a television including a detection unit to receive a command remotely and to a signal associated with the command to the data processing unit located within a back cabinet of the television situated behind the display unit.

5. The apparatus of claim 1 being a set-top box that receives digital content including an audiovisual program and a plurality of advertisements interspersed between segments of the audiovisual program and substitutes one of the plurality of advertisements with the advertisement image in response to the data processing unit detecting the fast-forwarding operation being conducted on the one of the plurality of advertisements.

6. The apparatus of claim 1, wherein data processing unit is adapted to detect the fast-forwarding operation and to output the static images of the advertisements only when the fast-forwarding operation involves a playback speed that is at least eight times greater than normal playback speed during viewing.

7. The apparatus of claim 1, wherein the fast-forwarding operation includes a skip operation that skips ahead a predetermine amount of the advertisement.

8. The apparatus of claim 5, wherein, prior to or upon detecting the fast-forwarding operation, the data processing unit analyzes control information within a packet partially forming the one of the plurality of advertisements to determine if the data processing unit is permitted to substitute the one of the plurality of advertisements with the advertisement image.

9. The apparatus of claim 8, wherein the data processing unit accesses a portion of the control information to select the advertisement as a substitute for the one of the plurality of advertisements.

10. The apparatus of claim 9, wherein the data processing unit accesses the portion of the control information being information identifying a genre of the one of the plurality of advertisements and selecting the advertisement corresponding to the genre of the one of the plurality of advertisements.

11. The apparatus of claim 1, wherein upon selecting the static advertisement image, the data processing unit outputs for display an expanded video of the advertisement.

12. The apparatus of claim 1, wherein upon selecting the static advertisement image, the data processing unit establishes a connection to a website that sells or distributes a product or service featured in the advertisement image.

13. The apparatus of claim 1, wherein upon selecting the static advertisement image, the data processing unit establishes a telephonic connection to a seller.

14. The apparatus of claim 1, wherein upon selecting the static advertisement image, the data processing unit generates a user interface to purchase an item associated with the advertisement image.

15. An apparatus comprising:
a tuner/demodulation unit adapted to receive digital content;
a data storage unit; and
a data processing unit coupled to the tuner/demodulation unit and the data storage unit, the data processing unit being adapted to detect an operation that accelerates playback of an advertisement being part of the digital content, and in response to detecting the accelerated playback, to retrieve a secondary advertisement from the data storage unit, to output an image for display that indicates an amount of time remaining in a display of at least the secondary advertisement, and to display the secondary advertisement, the secondary advertisement having a playback time less than a normal playback time of the advertisement.

16. The apparatus of claim 15, wherein data processing unit to detect a fast-forwarding operation being the accelerated playback.

17. The apparatus of claim 15, wherein data processing unit to detect the accelerated playback being a fast-forwarding operation less than one-eighth of the normal playback time of the advertisement.

18. The apparatus of claim 15, wherein data processing unit to detect the accelerated playback being a skip operation.

19. A method comprising:
receiving digital content including segments of a audiovisual program separated by at least one advertisement;
detect an operation that accelerates playback of the at least one advertisement; and
in response to detecting the accelerated playback, retrieving a secondary advertisement from a local memory storage unit;
outputting the secondary advertisement for display, the secondary advertisement having a playback time less than a normal playback time of the at least one advertisement; and
outputting an image for display that indicates a remaining duration for display of the secondary advertisement.
